(19) United States
(12) Patent Application Publication
(10) Pub. No.: US 2022/0348497 A1
(43) Pub. Date: Nov. 3, 2022

(54) GRANULES FOR ROOF COATINGS

(71) Applicant: Amberger Kaolinwerke Eduard Kick GmbH & Co. KG, Hirschau (DE)

(72) Inventors: Angela HULLIN, Erlangen (DE); Hans-Jürgen HOFMANN, Rottendorf (DE); Christian KOHL, Amberg (DE)

(21) Appl. No.: 17/730,490

(22) Filed: Apr. 27, 2022

(30) Foreign Application Priority Data
May 3, 2021 (EP) 21171758.2

(51) Int. Cl. C04B 18/02; C04B 20/10; C04B 20/12; C04B 26/26

(52) U.S. Cl. CPC C04B 18/021; C04B 20/1051; C04B 20/1022; C04B 20/126; C04B 26/26; C04B 2103/54

(57) ABSTRACT

Granules for a roof coating, wherein said granules comprise particles that have a coating, wherein said coating comprises at least one layer of an inorganic powder in a binder, wherein said inorganic powder has a d50 grain size of from 0.5 to 25 μm, and wherein a hydrophobizing and/or oleophobizing agent is present on said coating.

This application claims priority to EP patent application 21171758.2 filed May 3, 2021, to Hullin et al., entitled “Granules for Roof Coatings,” incorporated herein by reference.

The present invention relates to granules for roof coatings.

Bitumen-based roof systems are common as roof coatings in many countries, especially in the USA and Canada. Mostly, bitumen sheets sprinkled with granules are used in order to extend their service lives, improve them visually, and/or make them sure-footed, for example.

In many regions, the thus designed roof surfaces are exposed to intense solar irradiation, which may result in damages to the bitumen sheet on the one hand, and thus in leakage of the roof coating, and results in significant heating of the underlying rooms on the other hand. Therefore, the latter must be cooled with a high expenditure of energy. In order to reduce the heating of the roof system, bitumen sheets are employed that reflect a major part of the radiation, and thus reduce the heating significantly.

EP 2 483 494 B1 (Sexauer et al.) describes such a structure in which hydrophobically coated calcined kaolin serves as the granules.

For the same purpose, EP 3 164 554 B1 (Hofmann et al.) describes ceramic particles that are optionally hydrophobically coated.

US 2017/0158865 A1 describes solar-reflecting particles comprising a non-reflecting particle substrate, an inorganic binder, a pigment, and a hydrophobic coating. The pigment serves to achieve solar reflection. An influence on the anchoring thereof within the bitumen has not been described.

WO 2018/234942 A1 describes granules that may be employed, for example, as a roof coating. Thus, a non-reflecting core is surrounded by one or more layers, in order to achieve solar reflection and reduce the surface area.

In some cases, coating of the particles with hydrophobizing materials is customary, which deteriorates contact to the bitumen surface, because the surface energy of the substances used for the coating is close to the surface energy of bitumen. This detracts from the fixation of the particles within the bitumen, so that there is a risk that these will become detached from the bitumen when subjected to mechanical stress. Thus, the reflection of the thus coated surface as a whole decreases.

It has been the object of the present invention to provide granules for roof coatings that overcome at least some of the disadvantages of the prior art, especially improve the adhesion to bitumen.

The object is achieved by granules for a roof coating, wherein said granules comprise particles that have a coating, wherein said coating comprises at least one layer of an inorganic powder in a binder.

According to the invention, granules are prepared that are suitable for a roof coating. The granules include particles. These particles have a coating. This coating comprises an inorganic powder and a binder that binds the inorganic powder to the particles.

The coating used to improve the fixation of the particles to the bitumen may at the same time increase solar reflection.

Suitable particles include, in particular, calcined kaolin, calcined mixtures of clay minerals, feldspar and quartz, and calcined mixtures of clay minerals, silicates and oxides. Mixtures of the above may also be well employed.

Preferred are particles that show a high solar reflection even before the coating. A value of at least 80% is preferred, as measured according to ASTM Standard C 1549, as described in the Examples.

Suitable grain sizes for the particles are from 0.1 to 3 mm (d50 grain size). A “d50 grain size” means the value for which 50% by volume of the particles have a smaller grain size, and 50% by volume have a larger one. Such grain size distributions can be determined, for example, by a sieve analysis according to DIN 66165-2:2016-08.

The inorganic powder from which the coating is formed may preferably consist of calcined mineral powders, metal oxides, metal hydroxides, sulfates, silicate hydrates, glasses, carbonates, or mixtures of the above.

For example, alumina, iron oxide, magnesium oxide, zinc oxide or zirconium oxide may be employed as metal oxides.

Aluminum hydroxide and magnesium hydroxide, for example, are suitable as metal hydroxides. Suitable sulfates include barium sulfate and calcium sulfate.

The inorganic powder preferably has a d50 grain size within a range of from 0.5 to 25 μm.

The inorganic powder is preferably present in an amount of from 1 to 10% by weight, based on the weight of the granules.

Preferably, the binder is inorganic, too. Suitable binders include, in particular, siliceous binders, especially sodium water glass, potassium water glass, and mixtures thereof.

The binder is preferably present in an amount of from 0.3 to 5% by weight, based on the weight of the granules.

In some embodiments, it is preferred that the coating of inorganic powder and binder is applied repeatedly. In such a case, all the layers may have the same structure, or have different compositions.

In some embodiments, the coating also comprises a hydrophobizing or oleophobizing agent on the outside. Thus, the latter is applied onto the coating. Suitable agents for hydrophobizing or oleophobizing include siliceous compounds, fluorine-containing compounds, or siliceous fluorine-containing compounds, and mixtures thereof.

The hydrophobizing or oleophobizing agents are preferably present in an amount of from 0.05 to 2.0% by weight, based on the weight of the granules.

The invention also relates to a roof coating comprising a bitumen layer having granules according to the invention embedded therein. Typically, the granules are present in an amount of from 0.5 to 5 kg/m² of the roof coating.

The invention also relates to a process for producing the granules according to the invention, comprising the steps of

a) providing particles,
b) mixing the particles with a coating agent containing an inorganic powder,
c) drying the coating.

Further, it may be reasonable according to the invention to repeat steps b) and c) once or several times. Irrespective of the question of whether or not steps b) or c) are repeated, a hydrophobizing or oleophobizing agent may be applied afterwards.

The invention further relates to the use of a layer of an inorganic powder in a binder to improve the adhesion of granules to a bitumen layer.

Incorporation and spray-coating methods, in particular, are suitable for applying the coating to the particles. For this purpose, ploughshare mixers, shaft mixers, mixing drums or other suitable equipment may be used. Usually, the binder is diluted with water. The powder preferably shows a high solar reflection.

### DESCRIPTION OF THE FIGURES

FIG. 1A shows the material before the coating.

FIG. 1B shows the material according to Example 1.

FIG. 1C shows the material according to Example 2.

FIG. 2 shows an example of a cohesive failure in bitumen.

FIG. 3 shows an example of an adhesive failure in bitumen.

The invention is further illustrated by the following Examples.

### EXAMPLES

In the following Examples, granules are treated with the coatings according to the invention, whose compositions have been described in the patent EP 3 164 554 B1. They consist of a deliberately constituted composition of kaolin, feldspar, and crystalline silica in the form of quartz in ratios of 64:28:8% by weight.

### Example 1

A dispersion containing 30% by weight of calcined kaolin with an average grain diameter d50 of 7 μm (as measured using a Sedigraph 5120, applying the method described in the Zellcheming protocol V/27.3/90) was used as the anchoring layer. The product employed is sold by Amberger Kaolinwerke Eduard Kick GmbH & Co. KG, Hirschau (Germany), under the designation of AS 45/10.000. Sodium water glass (37° BE=degrees Baumé) in an aqueous dilution of 1:5 served as the inorganic binder. For each coating run, 1.8% by weight thereof was applied (dry matter of calcined kaolin, based on granules), i.e., 6% by weight of the dispersion, based on the granules.

### Composition of the Dispersion:

30% by weight of AS 45/10.000
11.7% by weight of Na water glass (37° BE)
58.3% by weight of water.

Three coatings were applied, with drying in between.

| | uncoated | 1 X coated | 2 X coated | 3 X coated |
|---|---|---|---|---|
| Reflection | 81.7% | 82.0% | 82.8% | 82.9% |

The reflection is determined according to ASTM Standard C 1549, “standard test method for determination of solar reflection near ambient temperature using a portable solar reflectometer”.

A suitable measuring device is available from the company Devices and Services, 2835 Virgo Ln., Dallas, Tex. 75229, under the designation of Solar Spectrum Reflectometer Model SSR.

### Example 2

A dispersion containing 30% by weight of alumina with an average grain diameter d50 of 4 μm (as measured using a Sedigraph 5120) was used as the anchoring layer. Alumina is available under the designation of “Nabalox TC 115” from Nabaltec GmbH, Schwandorf (Germany). Sodium water glass (37° BE) in an aqueous dilution of 1:5 serves as the inorganic binder. Three coatings were applied in the Example, with drying in between, wherein 1.8% by weight alumina was used in each case, based on the granules.

### Composition of the Solution:

30% by weight of Nabalox TC 115
11.7% by weight of Na water glass (37° BE)
58.3% by weight of water.

| | uncoated | 1 X coated | 2 X coated | 3 X coated |
|---|---|---|---|---|
| Reflection | 81.7% | 82.1% | 82.8% | 82.8% |

### Example 3

A dispersion containing 20% by weight of calcined kaolin with an average grain diameter d50 of 0.9 μm (as measured using a Sedigraph 5120) was used as the anchoring layer. This calcined kaolin is available from BASF OY, Helsinki, under the designation of “Ansilex 93”. Sodium water glass (37° BE) in an aqueous dilution of 1:5 serves as the inorganic binder. In this Example, three coatings were applied, with drying in between. For each coating run, 1.2% of Ansilex 93 was used, based on the granules.

### Composition of the Solution:

20% by weight of Ansilex 93
13.3% by weight of Na water glass (37° BE)
66.7% by weight of water.

| | uncoated | 1 X coated | 2 X coated | 3 X coated |
|---|---|---|---|---|
| Reflection | 81.7% | 81.8% | 82.6% | 82.7% |

These results show that the coating is able to increase reflection again.

Thus, the first part of the task is accomplished; the reflection is not deteriorated, but improved, by the coating.

### Analyses

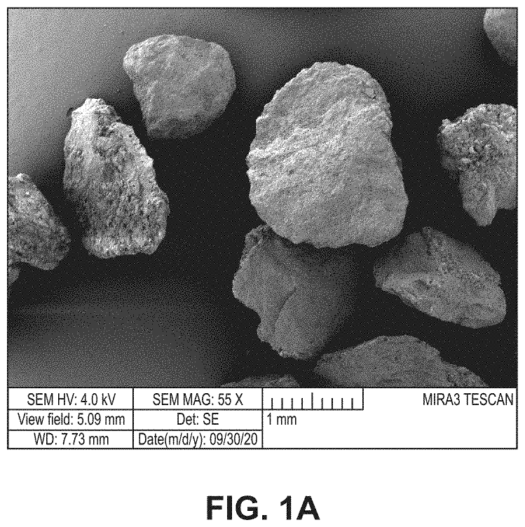

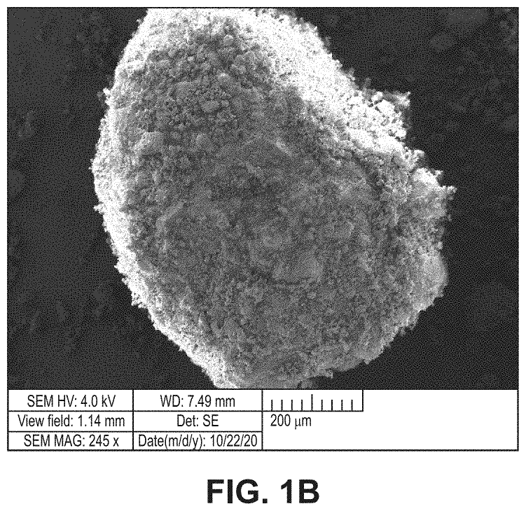

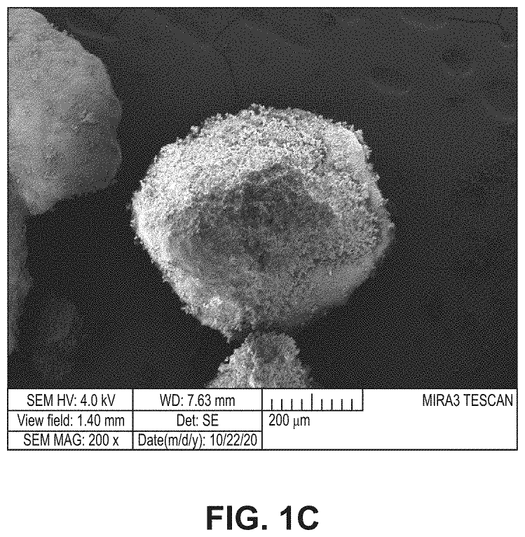

Of Example 1 and Example 2, scanning electron micrographs were made that show the change of the surface topography by the coating. From these, it is clearly seen that the coating causes a change in structure; the fractured surfaces, which are relatively smooth, become significantly rougher from the deposit of the particles in the coating, see FIGS. 1A to 1C.

### Example 4

The systems obtained in Examples 1-3 then received a further layer having a hydrophobizing and oleophobizing effect as the (n+1)th layer. The latter consists of an aqueous dilution [1:5 with water] of equal proportions of a silane (Silres BS 1001 from Wacker, Burghausen, Germany) and a fluorine-containing compound (Unidyne TG 8111, Daikin). For each coating run, 50 mg of dispersion per g of granules was applied.

### Example 5

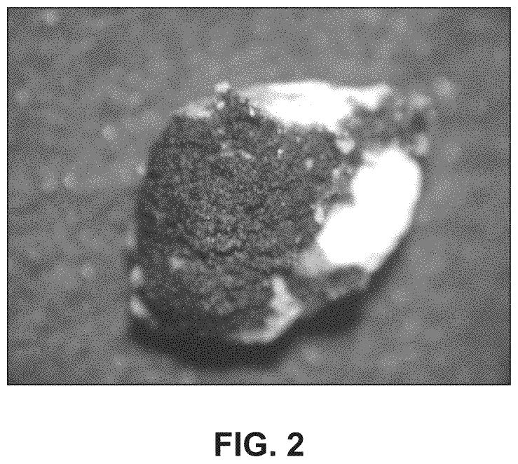

For verifying the fixation, the thus coated products of Example 4 were embedded into a bitumen matrix. For this purpose, the latter is heated at 200° C. for a short time. The embedded granules remained in storage at 80° C. for a curing time of 24 hours. After having coiled down to room temperature, the granules were torn out of the matrix using a pair of tweezers. It was evaluated whether the fracture was a (desirable) cohesive failure within the bitumen layer, or an adhesive failure, which would indicate weaker binding. In a cohesive failure, the bitumen layer breaks before the particle is detached from the bitumen layer. Such a fracture represents a course of fracture in the region of the bitumen that is not affected by the phase boundary. Such a fracture is a very good indication of high-quality adhesive bonding, see FIG. 2.

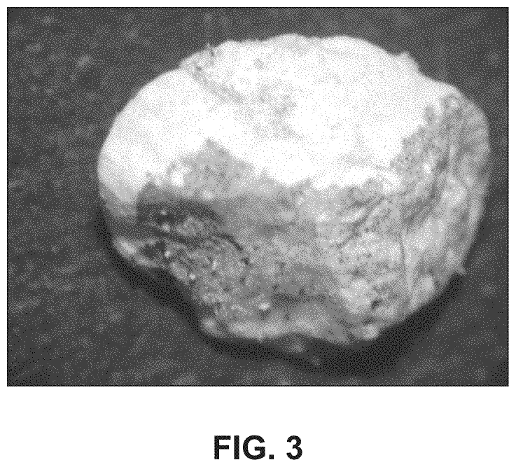

In an adhesive failure, the bitumen layer remains essentially intact. An adhesive failure is a fracture that runs along the phase boundary between the particle and bitumen. In this type of failure, a complete separation of the particle from the bitumen layer occurs. Since this idealized form of failure virtually never occurs in practice, cases with very thin adhering layers of bitumen are also referred to as “adhesive failure”, even though, strictly speaking, it would have to be referred to as an “almost 100% adhesive failure” in this case, see FIG. 3.

Hereinafter, particles that break when removed from the bitumen layer (cohesive failure in the adherend) are considered to be “sufficiently well fixed”. Together with the cohesive failures, this group forms the numerical value for the desired good fixation.

Granules that merely received the hydrophobizing and oleophobizing coatings serve as a reference.

| | | Cohesive failure | |
|---|---|---|---|
| | Adhesive | within the | within the |
| | failure | particle | bitumen |
| Reference + | 86% | 7% | 7% |
| hydro-/oleophobically coated | | | |
| Example 1 | 20% | 13% | 67% |
| Calcined kaolin d50 = 7 μm + | | | |
| hydro-/oleophobically coated | | | |
| Example 2 | 13% | 20% | 67% |
| Alumina + | | | |
| hydro-/oleophobically coated | | | |
| Example 3 | 13% | 60% | 27% |
| Calcined kaolin d50 = 0.9 μm + | | | |
| hydro-/oleophobically coated | | | |
| Reference, completely uncoated | 0% | 53% | 47% |

The data obtained show that the fixation is significantly improved by the coating.

1. Granules for a roof coating, wherein said granules comprise particles that have a coating, wherein said coating comprises at least one layer of an inorganic powder in a binder, wherein said inorganic powder has a d50 grain size of from 0.5 to 25 μm, and wherein a hydrophobizing and/or oleophobizing agent is present on said coating.

2. The granules for a roof coating according to claim 1, wherein said particles are selected from the group consisting of calcined kaolin, calcined mixtures of clay minerals, feldspar and quartz, calcined mixtures of clay minerals, silicates and oxides, and mixtures thereof, preferably wherein the particles have a solar reflection of at least 80% before being coated.

3. The granules for a roof coating according to claim 1, wherein said particles have a d50 grain size of from 0.1 to 3 mm.

4. The granules for a roof coating according to claim 1, wherein said inorganic powder is selected from the group consisting of calcined mineral powders, metal oxides, metal hydroxides, sulfates, silicate hydrates, glasses, carbonates, mica, and mixtures thereof.

5. The granules for a roof coating according to claim 1, wherein said inorganic powder has a d50 grain size of from 0.5 to 10 μm.

6. The granules for a roof coating according to claim 1, wherein said binder is an inorganic binder.

7. The granules for a roof coating according to claim 6, wherein said inorganic binder is a siliceous binder.

8. The granules for a roof coating according to claim 1, wherein said coating is applied repeatedly.

9. The granules for a roof coating according to claim 1, wherein the amount of inorganic powder is from 1 to 10% by weight, based on the weight of the granules.

10. The granules for a roof coating according to claim 9, wherein said hydrophobizing and/or oleophobizing agent is selected from the group consisting of siliceous compounds, fluorine-containing compounds, siliceous fluorine-containing compounds, and mixtures thereof.

11. A roof coating comprising a bitumen layer having granules embedded therein according to claim 1.

12. The roof coating according to claim 11, wherein the granules are present in an amount of from 0.5 to 5 kg per square meter of the roof coating.

13. A process for producing granules for a roof coating according to claim 1, comprising the steps of:
a) providing particles,
b) mixing the particles with a coating agent comprising an inorganic powder,
c) drying the coating,
d) optionally repeating steps b) and c), and/or
e) applying a hydrophobizing and/or oleophobizing agent.

14. The granules for a roof coating according to claim 2, wherein the particles have a solar reflection of at least 80% before being coated.
